(19) United States
(12) Patent Application Publication
(10) Pub. No.: US 2004/0175689 A1
(43) Pub. Date: Sep. 9, 2004

(54) Computer-assisted apparatus, method and program for learning

(75) Inventors: Kiyoshi Watanabe, Tokyo (JP); Kouzo Iwami, Tokyo (JP); Masayuki Miura, Tokyo (JP)

Correspondence Address: KANESAKA AND TAKEUCHI, 1423 Powhatan Street, Alexandria, VA, 22314, US

(73) Assignee: Graphin Co., Ltd.

(21) Appl. No.: 10/780,758

(22) Filed: Feb. 19, 2004

(30) Foreign Application Priority Data
Feb. 21, 2003 (JP) 2003-43502

(51) Int. Cl. G09B 25/00; G09G 5/00

(52) U.S. Cl. 434/365

(57) ABSTRACT

In a computer-assisted learning method for certainly mastering the learning contents through simulated experience, a display screen 16a is divided into multiple small screen sections; an explanation text display field, in which explanation text related to predetermined training contents is to be displayed, is assigned to any one of the small screen sections; and related-information display fields, in which detailed information and/or illustrated information associated with the contents described in the explanation text display field is to be displayed, are assigned to the remaining small screen sections. A trainee learns based on the explanation text and its related information.

### TECHNICAL FIELD

The present invention relates to a computer-assisted learning technique for enabling a user to certainly master the learning contents through simulated experience almost equivalent to experience of learning with the use of a real machine, by combining the contents of learning materials and information created based thereon, in teaching the learning contents to the user under the assistance of a computer.

The term “learning” used in this specification includes both of “education” for the purpose of “intellectual education, moral education and physical education” and “training” for the purpose of “technical/skill learning”.

### BACKGROUND ART

Recently, with the widespread of computers and the Internet, computer-assisted educational approaches called “e-learning” or “WBT (web-based training)” have been also rapidly spreading. As an example of such educational approaches, Japanese Patent Laid-Open No. 2002-149048, for example, discloses a method for realizing an operational-type learning environment in which an operation is performed directly to a learning target realized as simulation.

According to the prior-art technique, by configuring the operational-type learning environment with a user interface section and an operation control section separated from each other, it is possible to simplify editing and improve reusability.

However, according to the prior-art technique, though an operational-type learning environment can be realized, one theme can be displayed only as one whole screen. Therefore, there is a problem as described below. That is, when performing a flight training for a pilot following the display screens, for example, it is impossible to display necessary learning contents added to the existing learning materials (an operation manual) together with created information related thereto on the screen at the same time in order to make the user learn through simulated experience equivalent to experience of learning with the use of a real machine.

Accordingly, the object of the present invention is to provide a computer-assisted learning technique for displaying the contents of the existing learning materials and created information related thereto on the same display screen to provide a user with simulated experience equivalent to experience of learning with the use of a real machine, and thereby enabling the user to learn more certainly.

### SUMMARY OF THE INVENTION

The present invention has been made to achieve the above object, and a first invention (a learning apparatus) is a computer-assisted learning apparatus for displaying predetermined learning materials on a computer-controlled display screen to enable a trainee to learn based on the displayed content, wherein the display screen includes multiple small screen sections; any one of the small screen sections is assigned as an explanation text display field in which explanation text related to predetermined training contents is to be displayed; and the remaining small screen sections are assigned as related-information display fields in which detailed information and/or illustrated information associated with the contents described in the explanation text display field is to be displayed.

The above first invention includes the following two preferable aspects. That is, a first aspect is that the display screen includes the small screen sections as four equally divided screens; the detailed information includes an item as a dictionary for terms used in the explanation text; and the illustrated information includes illustration information, which is the illustrated contents of the explanation text, simulation information for experiencing the contents of the explanation text as simulation, and movie information for displaying the contents of the explanation text as animation.

A second aspect is that a screen zoom function enabling arbitrary change of the screen size of each of the small screen sections is provided.

A second invention (a learning method) is a computer-assisted learning method for displaying predetermined learning materials on a computer-controlled display screen to enable a trainee to learn based on the displayed content, wherein the display screen is equally divided into four small screen sections, the screen size of which is zoomable; any one of the small screen sections is assigned as an explanation text display field in which explanation text related to predetermined training contents is to be displayed; the remaining small screen sections are assigned as related-information display fields in which detailed information and/or illustrated information associated with the contents described in the explanation text display field is to be displayed; and thereby a trainee learns.

In the second invention described above, it is preferable that the detailed information includes an item as a dictionary for terms used in the explanation text; and the illustrated information includes illustration information, which is the illustrated contents of the explanation text, simulation information for experiencing the contents of the explanation text as simulation, and movie information for displaying the contents of the explanation text as animation.

The second invention described above includes an aspect that the simulation information is virtual reality information, and an aspect that the illustration information is graphic information including illustrations and photographs acquired from learning materials. Furthermore, it is preferable that the contents to be displayed in the small screen sections are exchangeable with one another.

The present invention includes a program to be installed in a computer, including learning information required for performing the computer assisted learning method, as a third invention (a program).

The program may be provided in a recording medium such as a semiconductor memory, a magnetic disk and a magneto-optical disk, or delivered via a network line such as the Internet.

### BRIEF DESCRIPTION OF THE DRAWINGS

FIG. 1 is a block diagram showing a schematic configuration example of a computer-assisted learning apparatus according to the present invention;

FIG. 2 illustrates a configuration example of a display screen provided for a display;

FIG. 3 illustrates an example of a file configuration retained by memory means;

FIG. 4 illustrates an example of creating a display screen when fifteen training steps are provided for one explanation item (a training item);

FIG. 5A illustrates a specific display condition of “Summary of Course”, the first training step for “Introductory Course for Private Pilot”; and

FIG. 5B illustrates a display condition of the second training step, “Cross-Country Flight”.

### DETAILED DESCRIPTION

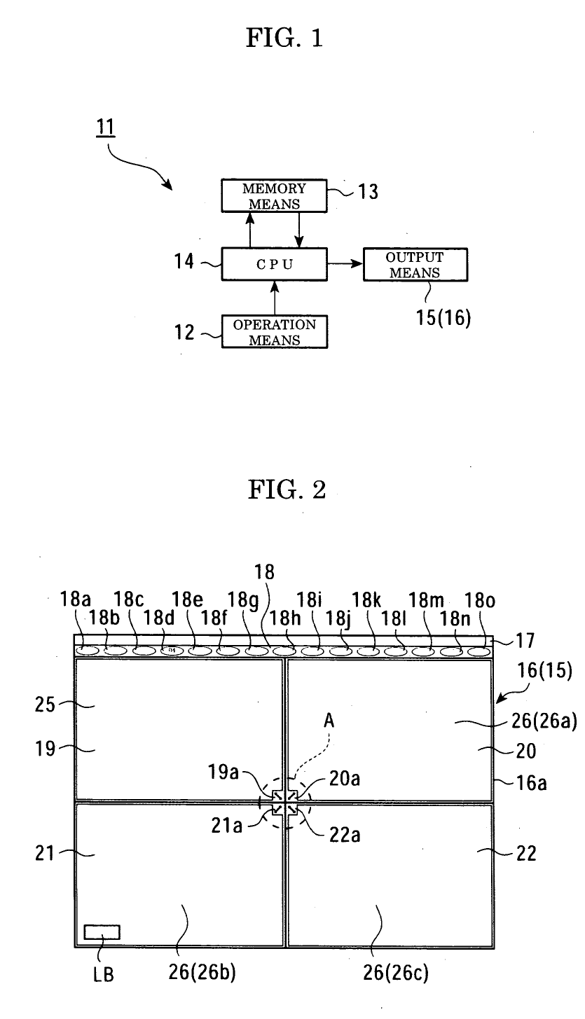

As shown in FIG. 1, a learning apparatus 11 includes operation means 12, memory means 13, central processing means (CPU) 14 and output means 15. The operation means 12 is a keyboard, a mouse or the like. The memory means 13 is a ROM, a RAM, a hard disk or the like. The central processing means 14 is control means for controlling the entire apparatus, and the processing capacity may be that at the level of a common personal computer. Though a display 16 such as a liquid crystal panel is used as the output means 15, a printer may be also used.

A trainee (a user) can learn by viewing the contents displayed in a display screen 16a provided for the display 16, as shown in FIG. 2.

In this example, the display screen 16a is provided with a title bar 17, a menu bar 18 and small screen sections 19 to 22. The title bar 17 is provided at the top of the display screen 16a, and a title or an item of the training contents is displayed thereon. The menu bar 18 is provided below the title bar 17, and in this example, there are arranged a total of fifteen item selection buttons 18a to 18o thereon. The small screen sections 19 to 22 are arranged below the menu bar 18 as equally divided four sections.

Though the small screen sections 19 to 22 are equally divided into four sections in this embodiment, the division number is not limited thereto and may be increased or decreased based on the number of tasks, such as division into three or six.

At the central part of the display screen 16a, which is denoted by a broken line A, there are provided four zoom buttons 19a, 20a, 21a and 22a for zooming the screen size of each of the small screen sections 19 to 22.

In this example, an oblique both-direction arrow is shown on each of the zoom buttons 19a to 22a. By putting the mouse pointer thereon and clicking the mouse button, a quarter-sized small screen is zoomed in to the full size of the display screen 16a. When the screen is full size, by putting the mouse pointer on any of the zoom buttons 19a to 22a and clicking it, the full-sized screen is zoomed out to the quarter-size. The mouse pointer and the mouse are not shown in the figure.

Among the small screen sections 19 to 22, the small screen section 21 positioned at the lower left, for example, is provided with an external link button LB. By operating the external link button LB, it is possible to display such information that cannot be expressed only with the small screen sections 19 to 22 (for example, instructions for use of parts and home pages of related companies) in a separate window (a browser) in a format such as 3DCG (three-dimensional computer Graphics), PDF (Portable Document Format) and HTML.

This separate window is displayed as a dedicated window on the screen of the display 16 by operating the external link button LB to call information on the linked target for related information and activate dedicated software stored in a storage device not shown.

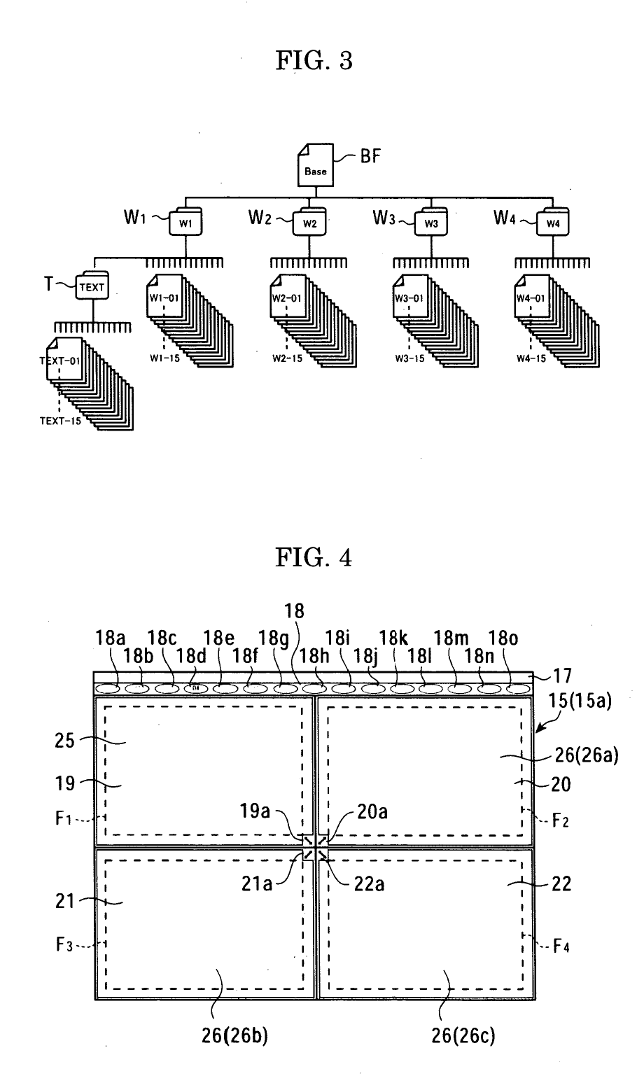

FIG. 3 illustrates an example of the file configuration held in the memory means 13. A base file BF is supplied as an execution file required for dividing the display 16 into the four small screen sections 19 to 22 to display necessary information. In the present invention, it is possible to pre-supply multiple base files in the HTML format and secure extensibility and developmentability based on the number of the base files, though it is not shown in the figure.

The base file BF hierarchically includes a first folder W₁ for the small screen section 19, a second folder W₂ for the small screen section 20, a third folder W₃ for the small screen section 21 and a fourth folder W₄ for the small screen section 22. Each of the folders W₁ to W₄ is configured as an execution file including module files to be displayed in each of the corresponding small screen sections 19 to 22.

This will be described in more detail with reference to an example shown in the figure. The first folder W₁ has an explanation text folder T and module files W₁-01 to W₁-15. The explanation text folder T includes text files TEXT-01 to TEXT-15 for a module for displaying explanation text in the explanation text display field 25 of the small screen section 19. The module files W₁-01 to W₁-15 are module data for managing the explanation text folder T. The explanation text folder T and the module files W₁-01 to W₁-15 are in association with each other.

In the text files TEXT-01 to TEXT-15 stored in the explanation text folder T, there is stored explanation text information acquired from the learning materials for each training item. In the illustrated example, for each one training item, necessary training contents are supplied as fifteen items of explanation text in the order of the corresponding training steps which have been created in advance.

The second folder W₂ has module files W₂-01 to W₂-15 for the small screen section 20. The third folder W₃ has module files W₃-01 to W₃-15 for the small screen section 21. The fourth folder W₄ has module files W₄-01 to W₄-15 for the small screen section 22.

In the second folder W₂, the third folder W₃ and the fourth folder W₄, there is stored information associated with the information stored in the first folder W₁. That is, the contents obtained by adapting the information stored in the first folder W₁ from a different viewpoint to give a better understanding thereof are included.

To explain this specifically, there is stored illustration information including illustrations and photographs in the second folder W₂, for example. There is stored simulated experience information (simulation information), which is virtual reality information including animations and simulations, in the third folder W₃. There is stored picture information acquired from video images, and movie information comprising picture information accompanied by narration, background music and the like in the fourth folder W₄.

Accordingly, the information in the text files TEXT-01 to TEXT-15 stored in the explanation text folder T can be reproduced in the explanation text display field 25 of the small screen section 19 by the control of the module files W₁-01 to W₁-15 supplied in the first folder W₁. Similarly, the information stored in the second folder W₂, the third folder W₃ and the fourth folder W₄ can be reproduced in a related-information display fields 26 (26a, 26b and 26c) of the small screen sections 20 to 22, respectively.

FIG. 4 illustrates an example of creating the display 16, in which fifteen training steps are supplied for an explanation item (one training item). The menu bar 18 is provided with the fifteen item selection buttons 18a to 18o. In each of the small screen sections 19 to 22, there can be displayed each of a total of fifteen patterns of training step information based on the selection from the item selection buttons 18a to 18o.

The maxim displayable area of the small screen sections 19 to 22 is within the invisible frames F₁ to F₄ denoted by broken lines in FIG. 4, respectively.

If the user clicks any desired button from among the item selection buttons 18a to 18o, for example, the fourth item selection button 18d as shown in the illustrated example, then the module file W₁-04 is read by the CPU 14 and the display contents are displayed in the small screen section 19. Similarly, the display contents of the module file W₂-04 are displayed in the small screen section 20; the display contents of the module file W₃-04 in the small screen section 21; and the display contents of the module file W₄-04 in the small screen section 22. The module files W₁-04 to W₄-04 are read at the same time.

The first folder W₁ stores the explanation text folder T which stores the text files TEXT-01 to TEXT-15 for a module for displaying explanation text in the small screen section 19, which are associated with the module files W₁-01 to W₁-15, and explanation text corresponding to any of the item selection buttons 18a to 18o that has been selected by the user is displayed in the small screen section 19.

Description will be now made on an example of a computer-assisted method for learning according to the present invention to be performed for a user with the use of the learning apparatus 11 configured as above. This learning method is performed by displaying necessary information on the display screen 16a provided for the display 16 included in the learning apparatus 11 interactively with the user.

In this case, the display screen 16a has been equally divided into the small screen sections 19 to 22 functioning as four display areas, the screen size of which can be freely zoomed, as described above. Among the small screen sections, the small screen section 19 can be used as the explanation text display field 25, into which necessary training contents are acquired from the learning materials including the necessary training contents as explanation text, in the order of training steps which have been created in advance for each of predetermined training items.

Each of the remaining small screen sections 20 to 22 is assigned as the related-information display field 26 in which detailed information and/or illustrated information associated with the contents described in the explanation text display field 25 is to be displayed.

The detailed information includes an item as a dictionary for terms used in the explanation text. The illustrated information includes illustration information comprising illustrations or photographs associated with the contents displayed in the explanation text display field 25; simulated experience information (simulation information), which is virtual reality information including animations and simulations; picture information acquired from video images; and movie information comprising the picture information accompanied by narration, background music and the like. The user can display the detailed information individually, or display any appropriate combination of the detailed information at the same time, in the related-information display fields 26 (26a, 26b and 26c) for use.

That is, the movie information can be outputted as picture information accompanied by narration or background music, which can be heard by the ear, to the related-information display field 26 (26a) of the small screen section 20 positioned at the upper right among the small screen sections 19 to 22.

The illustration information can be outputted as graphic information including illustrations and photographs acquired from the learning material, to the related-information display field 26 (26b) of the small screen section 21 positioned at the lower left among the small screen sections 19 to 22.

The simulated experience information can be outputted as virtual reality information including animations and simulations the image angle of which can be freely operated, to the related-information display field 26 (26c) of the small screen section 22 positioned at the lower right among the small screen sections 19 to 22.

Various information is outputted to each of the small screen sections 19 to 22 while organically associating the contents provided in the explanation text display field 25 and the contents provided in the related-information display fields 26 (26a, 26b and 26c) with each other. This makes it possible for the user to learn through interactive simulated experience.

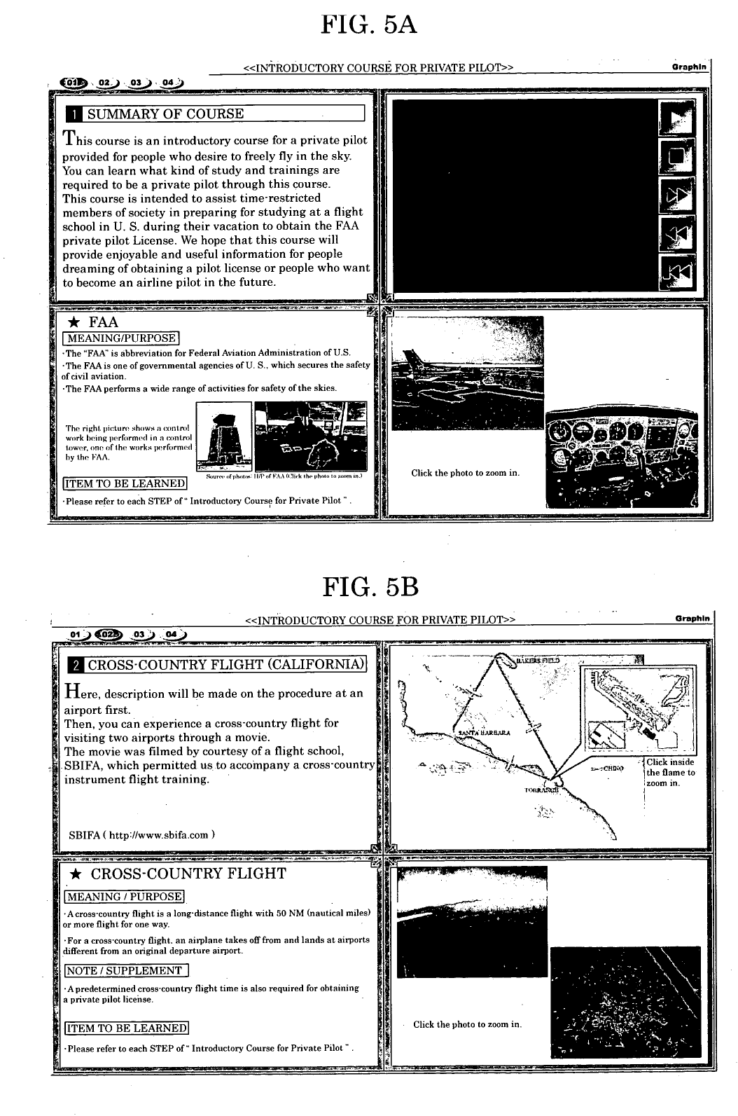

FIG. 5 specifically shows the contents displayed in each of the small screen sections 19 to 22 using “Introductory Course for Private Pilot” as an example. In this case, the menu bar 18 is provided with four item selection buttons 18a to 18d.

FIG. 5(a) shows a display pattern to be obtained by clicking the item selection button 18a. On the display screen 16a, the contents of the first training step under the training item “Introductory Course for Private Pilot” are displayed separately at the same time.

In the explanation text display field 25 of the small screen section 19, there is displayed explanation text acquired from the existing learning materials under the title of “1. Summary of Course” which is a first training step.

In the related-information display field 26a of the small screen section 20, there is displayed movie information associated with the explanation text shown in the explanation text display field 25. In the related-information display field 26b of the small screen section 21, there is displayed explanation of terms associated with the explanation text shown in the explanation text display field 25 together with photographs as illustration information. In the related-information display field 26c in the small screen section 22, there is displayed actual appearances of an airplane associated with the explanation text shown in the explanation text display field 25 as simulated experience information.

Thus, by reading the explanation text displayed in the explanation text display field 25 of the small screen section 19 while referring to related information associated therewith and outputted to the related-information display field 26a of the small screen section 20, the related-information display field 26b of the small screen section 21 and the related-information display field 26c of the small screen section 22, the user can understand the contents of the first training step under the training item “Introductory Course for Private Pilot”, from different viewpoints with great interest.

Furthermore, by clicking the zoom button 19a, for example, among the zoom buttons 19a to 22a provided for the small screen sections 19 to 22 of the display screen 16a, respectively, the corresponding small screen 19 can be zoomed in to almost the same size of the display screen 16a, and thereby very small characters can be easily read.

It is possible to display not only animation information (including video data) of an airplane associated with the explanation text shown in the explanation text display field 25 but also a zoomed-in view of an actual cockpit, in the related-information display field 26c of the small screen section 22. This makes it possible for the user to obtain a learning effect equivalent to that of a training with a real machine, through simulated experience.

In this way, when completing the first training step of the training item “Introductory Course for Private Pilot”, by clicking the second item selection button 18b, the contents of the second training step of the training item “Introductory Course for Private Pilot” are displayed in the explanation text display field 25 of the small screen section 19 of the display screen 16a and in the related-information display fields 26 (26a, 26b and 26c) separately at the same time, as shown in FIG. 5(b).

Similarly, as for the contents of the third training step and the contents of the fourth training step of the training item “Introductory Course for Private Pilot”, necessary information is outputted to the small screen sections 19 to 22 of the display screen 16a by clicking the third item selection button 18c and the fourth item selection button 18d, respectively, thereby enabling the user to understand the contents of the training in the order of the steps.

The program according to the present invention includes learning information required for performing the leaning method according to the present invention described above and can be installed on a computer. The program can be stored in a portable information medium such as a CD-ROM for supply.

According to the present invention, the contents to be outputted to each of the small screen sections 19 to 22 provided by equally dividing the display screen 16a are stored in a hierarchical structure and controlled based on the relation between the first folder W₁, the second folder W₂, the third folder W₃ and the fourth folder W₄, respectively. Therefore, even when a part of the contents are modified, it is only necessary to change the module file involved in the modification, and modification of the base file BF itself is not necessary.

Furthermore, the explanation text displayed in the explanation text display field 25 of the small screen section 19 can be changed only by changing the appropriate portion in each of the text files TEXT-01 to TEXT-15 stored in the explanation text folder T, and therefore modification work for the contents can be performed easily and promptly.

In addition, according to the present invention, extensibility can be also provided which enables improvement of the contents of the learning by growing the basic configuration of the base file BF, and thereby flexible response to various learning needs is possible.

The present invention has been described based on the illustrated example, but specific contents are not limited to the example. For example, output of the learning contents is not limited to display on a display screen, but may be performed by printing it on paper.

The number of training items and the number of training steps supplied for each of the training items may be set as desired or as required. Furthermore, information to be provided via each of the small screen section may be any information only if it makes it possible to learn along one learning theme from various viewpoints through simulated experience, and such output contents and output method that are selected based on the approach most suitable for illustration information or movie information for use may be used as those for each of the information.

As described above, according to the present invention, it is possible to appropriately assign and output at least explanation text information, illustration information, simulated experience information and a movie to small screen sections obtained by equally dividing the display screen into four, at the same time, and thereby it is possible for a user to efficiently learn through interactive simulated experience.

Furthermore, each of the small screen sections is provided with a zoom function which enables zoom-in to the original screen size and zoom-out to the size of the small screen section, so that even information including small characters and difficult to visually confirm can be easily confirmed visually.

Especially, since it is possible to output simulated experience information as virtual reality information including animation data to one small screen section, a user can obtain a learning effect equivalent to that of a training with a real machine, through the simulated experience while sitting before a computer.

In addition, the contents to be outputted to each of the small screen sections are controlled by a hierarchical structure comprising a first folder, a second folder, a third folder and a fourth folder constructed under a base file. Therefore, even when a part of the contents are modified, it is only necessary to change the module file involved in the modification and modification of the base file BF itself is not necessary.

Furthermore, explanation text displayed via a small screen section can be changed only by changing the appropriate portion in each text file stored in an explanation text folder, and therefore modification work for the contents can be performed easily and promptly.

In addition, according to the present invention, extensibility can be also provided which enables improvement of the contents of the learning by growing the basic configuration of the base file BF, and thereby flexible response to various learning needs is possible.

1. A computer-assisted learning apparatus for displaying predetermined learning materials on a computer-controlled display screen to enable a trainee to learn based on the displayed content, wherein
the display screen includes multiple small screen sections; any one of the small screen sections is assigned as an explanation text display field in which explanation text related to predetermined training contents is to be displayed; and the remaining small screen sections are assigned as related-information display fields in which detailed information and/or illustrated information associated with the contents described in the explanation text display field is to be displayed.

2. The computer-assisted learning apparatus according to claim 1, wherein
the display screen includes the small screen sections as four equally divided screens; the detailed information includes an item as a dictionary for terms used in the explanation text; and the illustrated information includes illustration information, which is the illustrated contents of the explanation text, simulation information for experiencing the contents of the explanation text as simulation, and movie information for displaying the contents of the explanation text as animation.

3. The computer-assisted learning apparatus according to claim 1 or 2, wherein a screen zoom function enabling arbitrary change of the screen size of each of the small screen sections is provided.

4. A computer-assisted learning method for displaying predetermined learning materials on a computer-controlled display screen to enable a trainee to learn based on the displayed content, wherein
the display screen is equally divided into four small screen sections, the screen size of which is zoomable; any one of the small screen sections is assigned as an explanation text display field in which explanation text related to predetermined training contents is to be displayed; the remaining small screen sections are assigned as related-information display fields in which detailed information and/or illustrated information associated with the contents described in the explanation text display field is to be displayed; and thereby a trainee learns.

5. The computer-assisted learning method according to claim 4, wherein
the detailed information includes an item as a dictionary for terms used in the explanation text; and the illustrated information includes illustration information, which is the illustrated contents of the explanation text, simulation information for experiencing the contents of the explanation text as simulation, and movie information for displaying the contents of the explanation text as animation.

6. The computer-assisted learning method according to claim 5, wherein
the simulation information is virtual reality information.

7. The computer-assisted learning method according to claim 5, wherein
the illustration information is graphic information including illustrations and photographs acquired from learning materials.

8. The computer-assisted learning method according to any one of claims 4 to 7, wherein the contents to be displayed in the small screen sections are exchangeable with one another.

9. A program to be installed in a computer, including learning information required for performing the computer assisted learning method according to any one of claims 4 to 8.
